(19) United States
(12) Patent Application Publication
(10) Pub. No.: US 2026/0123615 A1
(43) Pub. Date: May 7, 2026

(54) SPREADING DEVICE

(71) Applicant: Atli Mar JOSAFATSSON, Reykjavik (IS)

(72) Inventor: Atli Mar JOSAFATSSON, Reykjavik (IS)

(21) Appl. No.: 19/434,998

(22) Filed: Dec. 29, 2025

Related U.S. Application Data
(63) Continuation of application No. 17/920,481.
(60) Provisional application No. 63/028,089, filed on May 21, 2020.

(30) Foreign Application Priority Data
Apr. 22, 2020 (GB) 2005885.5

(51) Int. Cl. A01K 73/04

(52) U.S. Cl. CPC A01K 73/04

(57) ABSTRACT

A spreading device for spreading gear, including fishing gear or seismic survey gear, towed behind a vessel in water, comprising a hollow body of concavo-convex shape and made of plastics material. The body has a general mirror symmetry about a plane which is substantially mid-height and/or mid-length in the body in use. The body has a fore-and-aft to top-to-bottom aspect ratio of between 1:2 and 4:1, and an inner concave side and an outer convex side. The device has a forward towing point on the inner concave side for a tow line to the vessel and aft towing point for attachment of the gear to be towed. The plastic material of the hollow body renders the body buoyant in water and enables ballast or additional buoyancy to be added.

### CROSS REFERENCE TO RELATED APPLICATION

This application is for entry into the U.S. National Phase from which priority is claimed under all applicable sections of Title 35 of the United States Code including, but not limited to, Sections 120, 363, and 365 (c) to International Application No. PCT/EP2021/060274 filed on Apr. 20, 2021, and which in turn claims priority under 35 USC 119 to Great Britain Patent Application No. 2005885.5 filed on Apr. 22, 2020 and U.S. patent application Ser. No. 63/028,089 filed on May 21, 2020.

### BACKGROUND

The present invention relates to spreading devices for spreading gear towed in the sea or other bodies of water, in particular but not exclusively trawl doors for trawl fishing in general and deflectors for seismic survey operations.

Whilst spreading devices have other uses such as in seismic surveys, their primary use is as trawl doors, i.e. spreading devices towed by a trawler for spreading a trawl fishing net, that is holding it open. Trawl doors control opening of the fishing trawl, or plurality of trawl doors operating plurality of fishing trawls to optimize the fishing ability of the total fishing gear. Deflectors spread the seismic system with number of streamers or cables towed behind the seismic vessel.

They are used in pairs, one at one side of the trawl net and the other at the other. Water acts on their inner sides, which are oblique to their towed direction through the water and forces them apart. Traditional trawl doors have been flat. Increasingly for pelagic fishing in particular, curved trawl doors have been used. Forming trawl doors with complementary concave inner and convex outer surfaces, in the manner of an aerofoil, increases their efficacy, i.e. their net opening action per unit area. This form of door is readily manufactured for large doors by fabrication from sheet steel. However, such doors are expensive, heavy and disadvantageous for shallow water, bottom trawling with light gear. For such trawling, flat, relatively heavy, conventional trawl doors are still widely used. They have a damaging effect to the seabed.

### SUMMARY

According to the invention there is provided a spreading device for spreading gear towed behind a vessel in water comprising:
a hollow body of plastics material, the body being of concavo-convex shape and having:
general mirror symmetry about a plane which is substantially mid-height and/or mid-length in the body in use,
a fore-and-aft to top-to-bottom aspect ratio of between 1:2 and 4:1,
an inner concave side and
an outer convex side;
at least one forward towing point on the inner concave side of the body for a tow line to the towing vessel;
at least one aft towing point for the towed gear or a line to it, wherein:
the plastics material of the body renders the spreading device buoyant in water.

Preferably the spreading device includes righting ballast at least in a lower part of the device, whereby in use the spreading device is deployable outwards of a launching side of the vessel, spreading the gear in the direction of the convex outer side opposite from the forward towing point on the inner concave side.

In the preferred embodiments, the righting ballast is a shoe of material denser than water fitted to a lower edge of the device, with the lower edge preferably being locally thickened to fit a constant width of the shoe. The shoe can be of:
metal mechanically fitted to the body, conveniently of a plurality of channel sections of constant width, the body being locally swollen at least at its lower edge for location in the shoe or
plastics material filled with non-buoyant filler, bonded or mechanically fitted to the body.

Alternatively, the righting ballast is ballast material arranged inside the body of plastics material or on the outside of the body.

Normally, the or each forward towing point is substantially at or symmetrically positioned with respect to the mid-height plane. Similarly, the or each aft towing point is normally substantially at or symmetrically positioned with respect to the mid-height plane.

The or each aft towing point can either be on the outer convex side or the inner concave side of the body.

In use the tow line and the net or net line can be connected directly to the respective towing points. Alternatively, strops can be provided between the towing line and the net or net lines. A single forward and a single aft tow point can be provided. Normally at least one forward and two aft towing points are provided, with the aft towing points being on the outer side or at the inner side. Other simple alternatives are two forward & two aft towing points and two forward & one aft towing points envisaged. Further in the interests of spreading load to the plastics material body more towing points, with appropriate length of strops to common points of attachment to a towing line and/or a net or net line, are also envisaged.

The forward and aft tow points can be interconnected through the body or by external plates. Normally the plates will be of steel with welded eyes and bolts through the body to back plates on the opposite sides of the body.

In preferred embodiments, the body is moulded of thermo-softening plastics material by rotational moulding. Rotational moulding is a well-known and standard method of moulding plastics materials. This technique enables the use of virgin and/or recycled plastic materials, and pellets or powders, provided they have a good melting ability. Typically, a mixture of virgin and recycled plastics may be used. Typically, a wall thickness of 8-20 mm may be used, preferably 10-16 mm, and most preferably 10-12 mm.

Alternatively, to rotational moulding, the plastics material can be extruded or 3D printed. Usually, the plastics material may be a thermo-softening plastics material. The spreading device made this way will also typically have a wall thickness of 8-20mm, preferably 10-16 mm, and most preferably 10-12 mm. These ways of forming the body lead to additional buoyancy over and above buoyancy resultant from the material of the body being buoyant. In this case additional ballast is provided to counteract the nature of the body. The additional ballast can be provided by augmenting the righting ballast as by inserting ballast material inside the hollow body or securing it on the outside, for instance as a heavier shoe.

Providing the body as hollow significant advantages to the function of the device and for the manufacture thereof. Advantageously, the body is light weight, using less material than a solid body. This reduces material costs. In addition, the hollow structure enables the body to be provided with a suitable quantity of ballast or buoyance aid for the use to which the spreading device will be put. For example, where the gear needs to be positioned in mid-level or in deep water, ballast of steel, sand or concrete made be placed in the hollow body.

Alternatively, where the gear needs to be positioned high in the water, additional buoyancy may be added to the hollow body, for example a foam material. These methods of production also enable the wall thickness of the device to be increased to increase strength without a very significant gain in weight.

Alternatively or additionally, to providing additional ballast to provide stability, the body can be provided with apertures in the wall of the plastics material body to enable water to fill the hollow interior of the body. As the body fills with water, this will provide neutral buoyancy, but as the body is made of plastics material, it will still be buoyant in the water.

Another advantage of the use of a hollow body is that this enables apertures to be placed in the body to allow sea water to flow into and through the body and prevents cracking under high pressure deep water. This enables the device to be made of a plastics material. As noted above, typically trawl doors and the like are made of sheet metal, typically steel, making them expensive, heavy and difficult to manufacture, and also limiting their use. The provision of the spreading device in hollow plastic broadens the use of the device and makes it suitable for a much broader range of uses. For example, the device can be used in shallower water than conventional spreading devices.

Normally the spreading devices will be provided in pairs of one starboard device and one port side device, with the bodies of the pair of spreading devices being from the same mould. The bodies of the two devices can be:
arranged oppositely fore and aft with respect to their mid-length plane,
be thickest substantially at their mid-length plane and preferably
have their sides substantially circularly curved with the inner concave sides being less curved than the outer convex sides.

Alternatively, the bodies of the two devices can be:
arranged oppositely top to bottom with respect to their mid-height plane and preferably having:
rounded forward edges,
greatest thickness forward their mid-length plane and
tapered aft edges.

### BREIF DESCRIPTION OF THE DRAWINGS

To help understanding of the invention, two specific embodiments thereof will now be described by way of example and with reference to the accompanying drawings, in which:

FIG. 1 is a diagrammatic perspective view of a pair of spreading devices in the form of trawl doors holding open trawl net being towed by a trawler;

FIG. 2 is a diagrammatic plan view of the starboard trawl door of the two doors of FIG. 1, showing forces in the horizontal plane;

FIG. 3 is a side view of the starboard trawl door, showing forces in the vertical plane;

FIG. 4 is a normal side view of the starboard trawl door, showing planes of symmetry;

FIG. 5 is a mid-height cross-section plan view, on the line V-V in FIG. 4, showing radii of curvature of parts of a body of the starboard door;

FIG. 6 is a cross-sectional side view similar to FIG. 5, showing towing eye bolts and cross tubes, the section is on the lower bolts of the inner towing eye, i.e. on the line VI-VI in FIG. 4;

FIG. 7 is a further view similar to FIG. 5, on the line VII-VII in FIG. 4 ;

FIG. 8 is a cross-sectional view of the door on the line VIII-VIII in FIG. 6;

FIG. 9 is a cross-sectional view of the door on the line IX-IX in FIG. 6;

FIG. 10 is a perspective view of another trawl door of the invention;

FIG. 11 is a mid-height sectioned view of the lower half of the door of FIG. 1;

FIG. 12 is a cross-sectional plan view corresponding to FIG. 5; and

FIG. 13 is a view similar to FIG. 4 showing a variant of its door.

### DETAILED DESCRIPTION OF THE INVENTION

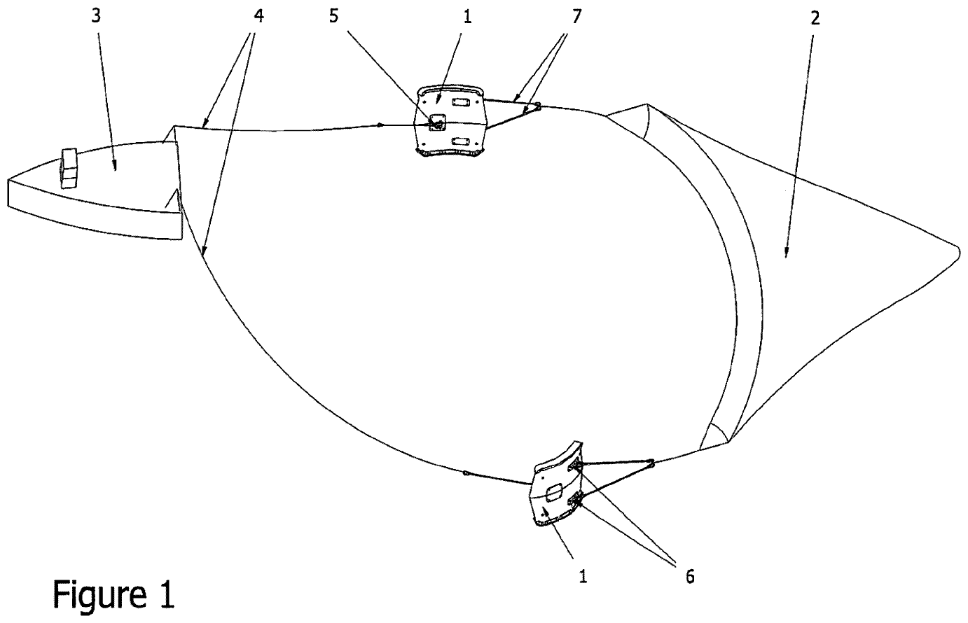

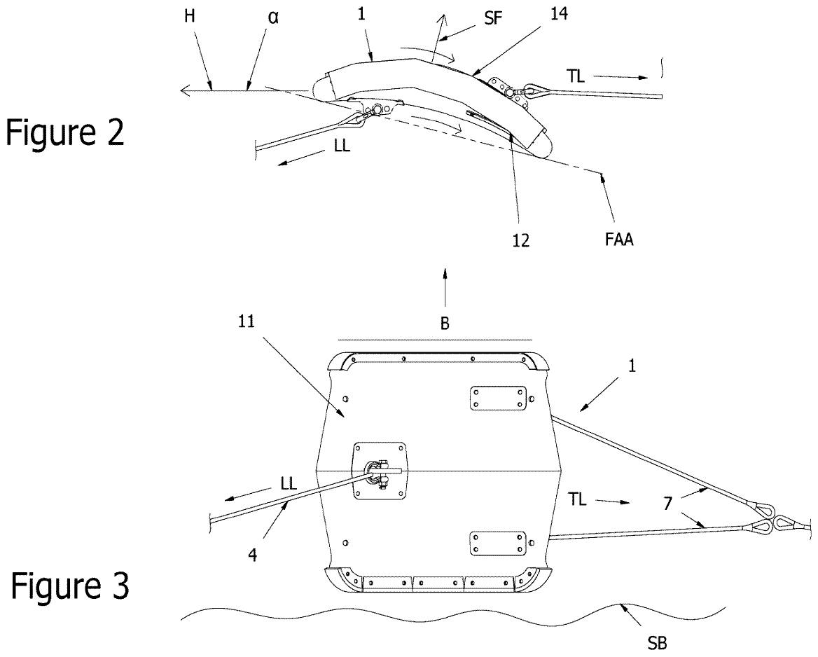

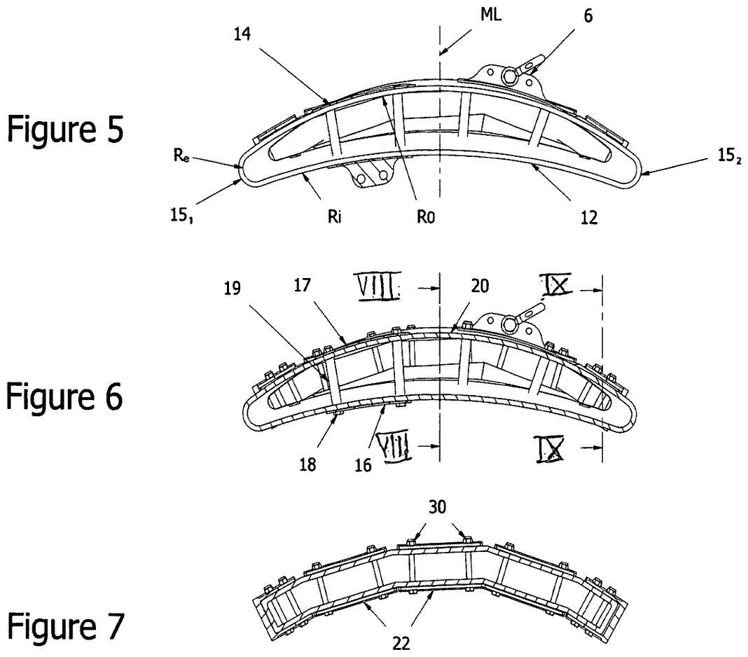

Referring to FIGS. 1 to 7 of the drawings, a pair of starboard and port side trawl doors 1 for a trawl net 2 towed by a trawler 3 are shown. Two towing lines 4 from the trawler are connected to the trawl doors at forward towing eyes 5. The doors have aft towing eyes 6 from which extend strops 7 attaching the trawl doors to the trawl net. In these respects, the trawl doors are conventional.

In accordance with the invention, the two trawl doors have polymeric bodies 11, rendering the doors buoyant. The bodies of the port side and starboard doors are identical and from the same mould-not shown. They are moulded by rotational moulding, with the result that they are hollow. Thus, the bodies are buoyant from the buoyant nature of the polymer of which they are moulded. Counteracting the buoyancy to a level whereby the righting ballast will draw them down to the bottom will be discussed below following description of the shape of the bodies. However it should be noted here with reference to FIG. 3, that the trawl doors have sufficient buoyancy to remain off the seabed SB. Additionally or alternatively, the trawl net having negative buoyancy, albeit with the bottom of its mouth being weighed down with weights whilst the top of its mouth is held up by floats, the trawl net itself may balance the buoyancy of the trawl doors, the trawl net load being applied as TL. Further as is known in itself, the strops 7 may extend directly to the top and bottom ends of the trawl mouth or they may be brought together to a single line extending towards the trawl, the line itself branching near the net to the top and bottom ends.

The polymeric bodies 11 comprise the greater part of the trawl doors 1 and are acted on by water flow as they are towed. They are mirror image symmetrical about their mid-length plane ML. As such they are not of conventional aerofoil/hydrofoil shape i.e. they do not have a thickness which is greatest close to their leading edge and tapering to a fine trailing edge. They are however shaped to experience “lift”, directed sideways of their travel through the water. This is achieved by their inner faces 12, facing each other across the width of the trawl, being at least substantially circular curved with a radius of curvature Ri; whilst the outer faces 14 have a lesser radius Ro of curvature, both radii being centred at the same point (not shown) in the mid-length plane. With the leading/trailing edges 15 having a much smaller radius of curvature Re, i.e. a thickness of substantially 2Re; the thickness at the mid-length plane ML is equal to (Ro Ri), i.e. greater than 2Re. The water flow around the outside face 14 is therefore faster and causes side-force SF tending to keep the trawl net open. Further the angle of attack a, between the direction of haul H and a nominal fore-and-aft plane of the trawl door FAA, caused by the forward towing eye 5 being on inner face 14 and the two aft towing eyes 9, 10 being on the outer face, contributes to the side-force.

The towing eyes have support plates 16, with backing plates 17 on opposite faces of the body. The plates 16, 17 are opposite each other and held against the body by bolts 18. To avoid tightening of the bolts causing local collapse of the hollow bodies, sleeves 19 are provided for the bolts 18. The sleeves extend through the walls 20 of the bodies and abut the plates 16, 17.

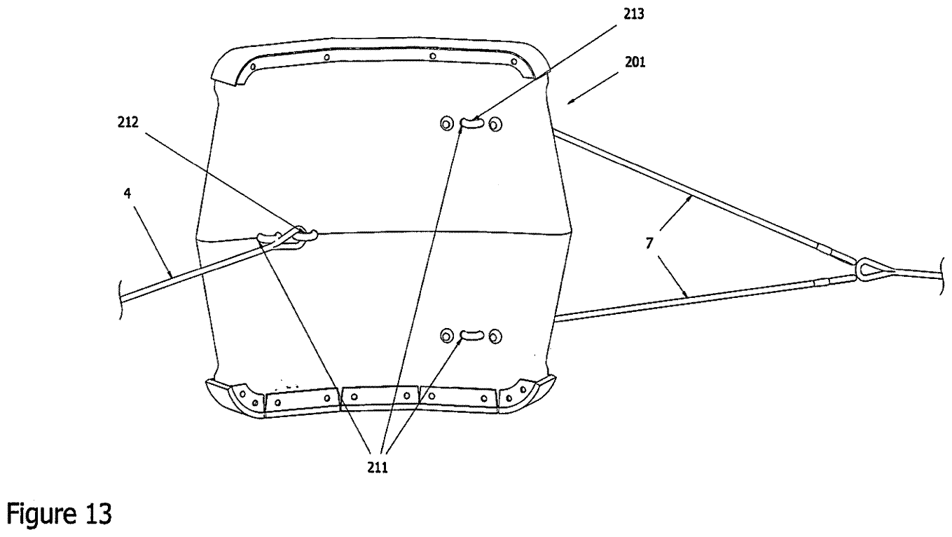

Alternatively, as shown in FIG. 13, the body can be fitted with holes, position in similar location as the towing eyes. A simple rope can be threaded through the holes 211, fastened at the opposite face of the body and used as trawler line and trawl line towing eyes 212, 213.

To counteract the buoyant nature of the bodies, apertures 20I, 20U are provided in the body walls, preferably positioned at both low and high position of the body to allow the water to flow through the inside of the body.

To counteract the buoyant nature of the bodies due to them being of plastics material, they are provided with shoes 22 at their lower edges 23. The bodies have upper and lower margins which are of constant width and divided into straight sections 24, which generally follow the curved shape of their body. The straight sections are mutually angled with respect to their neighbours. The shoe fitted to each body comprises one or several of short channel sections 25, which can be fabricated from plate steel or cast. The end ones of the channel sections are formed with curved ramps 28 to enable the doors to ride over higher point above the general level of the seabed. The lower edges are shaped at their ends complementarily to the curved ramps 28. With the thickness of the bodies being a maximum at the mid-length plane ML, and decreasing to the leading and trailing edges, at the mid-length plane the thickness is at once thinned in a margin 29 to the lower edge and thickened at the leading and trailing edges. The shoes are secured by bolts 30, The shoes act as a keel on deployment of the trawl door, weighing down the lower edge and applying righting action. Thus, the pair of doors on either side of the trawl net deploy with their convex faces out and their concave faces in and facing each other.

Conveniently the upper edges 31 of the bodies are formed similarly to the lower edges, with caps 32 lighter than the shoes can be fitted to the upper edges.

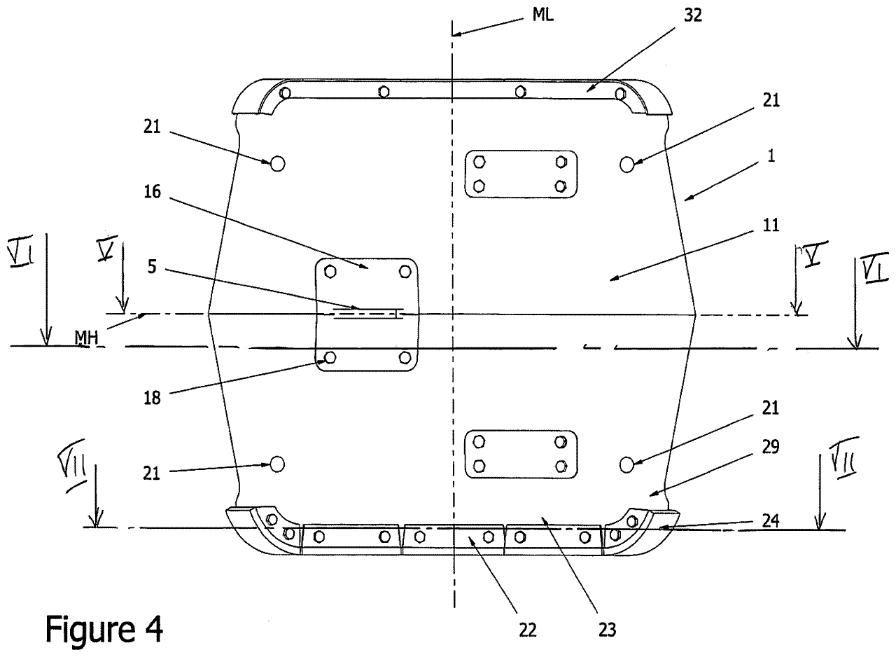

In this embodiment, the bodies have mirror image symmetry about both their mid-height plane MH and their mid-length plane ML To enhance the efficacy of the trawl doors, the bodies are longer fore and aft at the mid-height plane H than at the upper and lower edges 31, 23. Thus, the bodies have an unequal angle hexagonal shape inside view, as seen in FIG. 4. They are also angled out slightly with respect to their mid-height plane to give them a stable upright orientation. This is particularly advantageous if the eye arrangement is modified to a single trawler line towing eye on the inner concave side and a single trawl net towing eye on the outer convex or inside concave side.

The aspect ratio of this embodiment is 1:1, considering that its top to bottom dimension is the same as the length dimension along the shoe/cap. The longest dimension of the body, i.e. its mid-height length is 10% greater. Thus, the aspect ratio might be thought to be 1:1.1, however we refer to refer to it as 1:1.

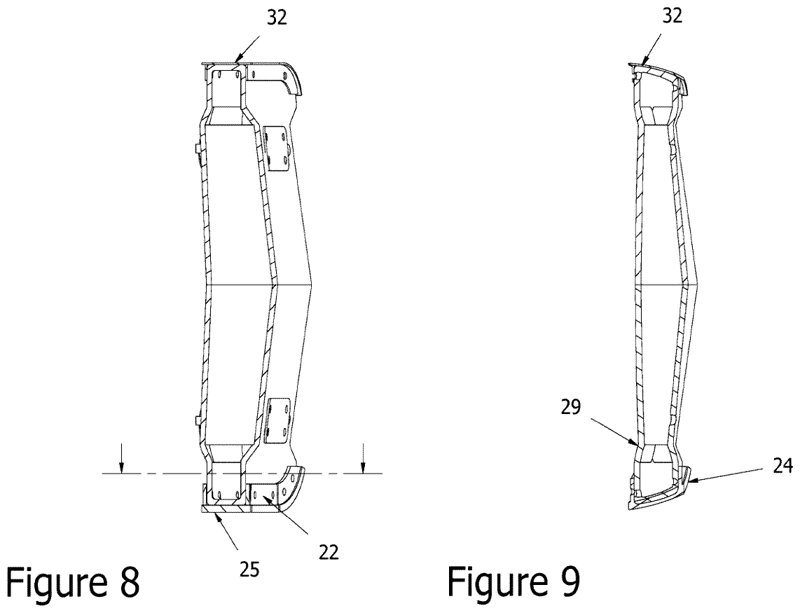

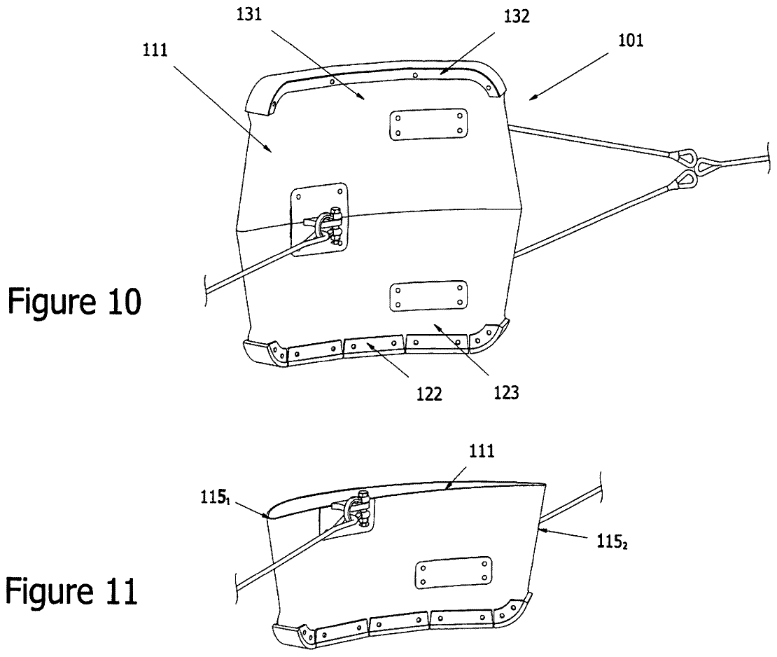

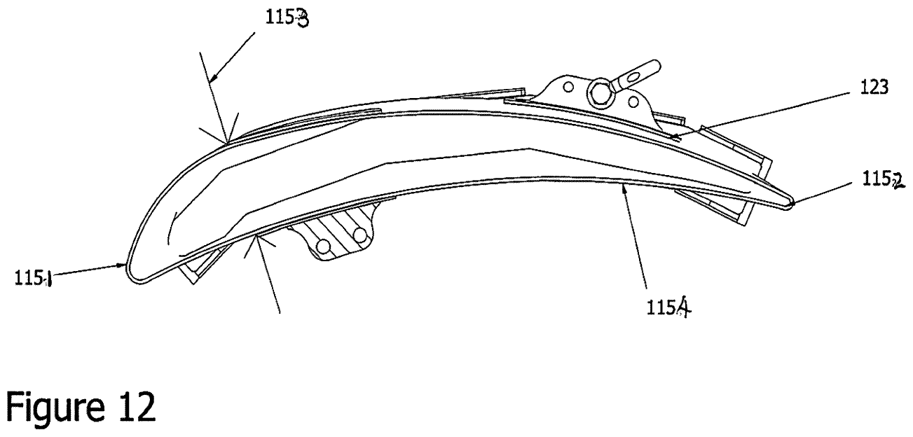

We anticipate that a shorter/longer aspect ratio of up to substantially 1:2 will operate satisfactorily in accordance with the invention. Equally a taller/narrower aspect ratio of up to substantially 2:1 will also do so. Indeed, we expect even taller/narrower ratios to 4:1 to work, even if being on the borderline of stability when used off to the seabed or in mid water as pelagic doors. Turning now to FIGS. 10, 11 & 12, the trawl door 101 shown there are essentially similar to that of FIG. 1 to 12, except for the cross-sectional shape its plastics material body 111. This is more akin to that of an aerofoil in having:
A relatively thick leading edge 1151,
A maximum thickness position 1153 between the leading edge and the mid-length plane,
A tapering shape 1154 extend aft from the maximum thickness position and
A fine trailing edge 1152.

This shape is of course also concavo-convex, but not mirror symmetrical about its mid-length plane as the first embodiment is. It is though likely to generate a greater lateral “lift” than the first embodiment shape of FIGS. 1 to 12. It is however mirror symmetrical about its mid-height plane. Thus, with the top and bottom edge thickenings 131, 123 being identical for its shoe 122 and capping 132 the opposite trawl doors can have identical, but upside-down, bodies. In other words, the opposite bodies can be made in the same mould.

Trawl doors of this shape are in other respect, including the slight elongation along the mid-height plane and the slight outwards angle of the upper and lower parts above and below this plane. However, it should be noted that in variants of both embodiments, these features can either or both of them be omitted.

The invention is not intended to be restricted to the details of the above described embodiment. For instance, the trawl doors can be made more or less buoyant for pelagic fishing.

The preferred embodiments have been described as being moulded of plastics material in a rotational mould. It is expected that polypropylene will be the preferred material, not least because it is the most widely used polymer and thus most widely available for recycling. As an alternative to rotational moulding, injection moulding, extrusion and/or 3D printing can be used. The polymer may be plain or filled.

Alternatively, the body can be made from wood fibres or a blend of wood fibres and polymers by rotational moulding, injection moulding, extrusion and/or 3D printing. A body made from wood fibres which are heavier in water but will still need shoes to keep correct balance.

The upper and lower margins can alternatively be circularly curved, with the caps and shoes being circularly curved channels. Again, the margins can be dispensed with, with the body shape extending to the top and bottom of the body. In this case the caps and shoes are shaped complementarily to the body shape.

1. A spreading device for spreading gear towed behind a vessel in water comprising:
a hollow body of plastics material, the body being of concavo-convex shape and having:
general mirror symmetry about a plane which is substantially mid-height and/or mid-length in the body in use;
a fore-and-aft to top-to-bottom aspect ratio of between 1:2 and 4:1′
an inner concave side; and
an outer convex side;
at least one forward towing point on the inner concave side of the body for a tow line to the towing vessel;
at least one aft towing point for the towed gear or a line to it;
wherein the forward and aft tow points are interconnected through the body;
wherein the plastics material of the body renders the spreading device buoyancy in water;
wherein the body is moulded by rotational moulding or extrusion or 3D printing;
wherein the device further includes righting ballast at least in a lower part of the device, whereby in use the spreading device is deployable outwards of a launching side of the vessel, spreading the gear in the direction of the convex outer side opposite from the forward towing point on the inner concave side, the righting ballast being ballast material arranged inside the body of plastics material or on the outside of the body.

2. The spreading device as claimed in claim l, wherein the at least one forward towing point is substantially at or symmetrically positioned with respect to the mid-height plane.

3. The spreading device as claimed in claim l, wherein the at least one aft towing point is substantially at or symmetrically positioned with respect to the mid-height plane.

4. The spreading device as claimed in claim l, wherein the at least one aft towing point is on the outer convex side of the body.

5. The spreading device as claimed in claim 1, wherein the at least one aft towing point is on the inner concave side of the body.

6. The spreading device as claimed in claim l, wherein the towing points are provided with load spreading plates on the opposite side of the body and bolts through the body for transferring the load to the plates.

7. The spreading device as claimed in claim 5, wherein at least one of the load spreading points on one side of the body is connected to at least one of the towing points on the same side of the body for towing load transfer from the towing point bolted to the load spreading plate to the connected towing point, the connection being an integral metal connection or a bolted metal to metal connection.

8. The spreading device as claimed in claim 1, in combination with at least two strops for forward ones of the towing points or for aft ones of the towing points for connection to the tow line or the gear line.

9. The spreading device as claimed in claim l, wherein:
the body is moulded of thermo-softening plastics material by rotational moulding or extrusion or 3D printing and is hollow and provides the device with additional buoyance over and above inherent buoyancy of the plastics material; and
wherein the spreading device is provided with additional ballast to counteract the additional buoyancy.

10. The spreading device as claimed in claim 1, wherein:
the body is moulded of thermo-softening plastics material by rotational moulding or extrusion or 3D printing and is hollow and provides the device with additional buoyance over and above inherent buoyancy of the plastics material; and
wherein the body is provided with apertures in the wall of the plastics material body to enable water to fill the hollow interior of the body.

11. The spreading device as claimed in claim l, wherein the body is of wood fibres or a blend of wood fibres and polymer.

12. The pair of spreading device, each as claimed in claim l, wherein one is a starboard device and the other is a port device, the bodies of the pair of spreading devices being from the same mould, the bodies of the two devices:
being arranged oppositely fore and aft with respect to their mid-length plane;
being thickest substantially at their mid-length plane; and preferably having their sides substantially circularly curved with the inner concave sides being less curved than the outer convex sides.

13. The pair of spreading device, each as claimed in claim 1, wherein one is a starboard device and the other is a port device, the bodies of the pair of spreading devices being from the same mould, the bodies of the two devices:
being the arranged oppositely top to bottom with respect to their mid-height plane and preferably having rounded forward edges,
greatest thickness forward their mid-length plane, and
tapered aft edges.
